(19) United States
(12) Patent Application Publication
(10) Pub. No.: US 2013/0234852 A1
(43) Pub. Date: Sep. 12, 2013

(54) CONTAINER SENSOR SYSTEM

(71) Applicants: Gerald Sena, Farmingdale, NJ (US); Dan Quackenbush, Poughkeepsie, NY (US)

(72) Inventors: Gerald Sena, Farmingdale, NJ (US); Dan Quackenbush, Poughkeepsie, NY (US)

(21) Appl. No.: 13/779,028

(22) Filed: Feb. 27, 2013

Related U.S. Application Data
(60) Provisional application No. 61/607,293, filed on Mar. 6, 2012.

(51) Int. Cl. G08B 21/18

(52) U.S. Cl. CPC G08B 21/182
USPC 340/540

(57) ABSTRACT

A sensor system operable to detect the level of product in a container includes a sensor, controller and indicator to alert an operator of a condition in the container. The system detects the level of product in a container. The system is operable to send a signal to a vendor source so that the product may be restocked without the need for the proprietor of the container to contact the vendor independently.

### CROSS-REFERENCE TO RELATED APPLICATIONS

This application claims the benefit of U.S. Provisional Patent Application No. 61/607,293, filed Mar. 6, 2012, the entirety of which is incorporated herein by reference.

### FIELD OF THE INVENTION

The present subject matter is directed to a sensor system, and more particularly to a sensor system operable to detect the level of product in a container.

### BACKGROUND

Stores often use containers to hold product which is accessible and removable by customers. For example, ice boxes on the premises of many stores contain loose, bagged or block ice for purchase by customers. Because these containers are closed, it is not always apparent when the inventory of product in the container gets low. It is up to the store manager or employee to check the level of product in the container and call the supplier to restock the product.

Sometimes, a store employee will call to restock product without checking the level of inventory in the container. This results in a visit from the supplier, and in cases where the inventory is not low, a wasted trip by the supplier, resulting in wasted fuel, time and, in the case of perishable items, potentially inventory.

Thus, it would be advantageous to provide a sensor which reads the level of inventory in the container, and provides a signal that inventory is low.

### SUMMARY OF THE INVENTION

The presently disclosed subject matter is directed to a sensor operable to read the level of inventory in a container and provide a signal indicating that the container is ready to be restocked. Unlike conventional load cells which measure the weight of product, are expensive to install and are subjected to continuous, often heavy loads, leading to failure over time, the presently disclosed sensors employ an electronic transmitter and receiver which avoid load stress and are simple and inexpensive to install.

In accordance with one aspect for example a sensor is provided which is operable to be mounted in an ice storage container and senses the level of ice in the container and signals when the level reaches a depth indicating restocking is necessary.

In accordance with one embodiment a sensor is provided which includes a transmitter operable to transmit a signal in the direction of product in a container and a receiver operable to receive a return signal. The time it takes the transmitted signal, such as a tone, to return to the receiver is processed and translated into distance, providing a measurement of the distance from the top of the product to a given point in the container. A controller may include a switch adjustable to provide the level of product below which a signal is activated indicating the product level is low and should be restocked. In one embodiment, once the product level goes beyond the preset limit, an indicator such as a light, alarm, wired or wireless signal, etc. is activated, which may remain activated until the product is restocked above the preset level.

In accordance with one embodiment the sensor is connected to a power supply and a controller which may include digital and/or analog input and is operable to provide an output signal to an alert device such as an indicator, transmitter or computing device.

The sensor may be mounted to the top of a container such as an ice container and connected to any suitable power supply. In one embodiment an alert device may include an indicator, such as a light, mounted on the container so that the low level will be apparent to a person responsible for restocking the container. In accordance with one embodiment an inventory monitoring system operable to read the level of inventory in a container and provide a signal indicating that the container is ready to be restocked, the system including a sensor mountable in a position on or within a container and operable to transmit a signal into an interior of a container to a target surface of an inventory in a container and receive a return signal, the sensor operably linked to a controller, and an alert device operably linked to the controller wherein the controller is operable to provide an output signal to the alert device when the level of inventory in a container falls below a preset level.

In one embodiment of the system the sensor includes an ultrasonic depth measurement device operable to measure the time required for an ultrasonic pulse delivered from the sensor to travel to and from a target surface. A distance from the sensor to a target surface may be output as an analog signal between 0 to 10 volts. In one embodiment a 0-10 volt signal from the sensor is employed using 2 resistors to form a voltage divider wherein the controller only receives 0-5 volts. The sensor may employ width modulation (PWM). A distance from the sensor to a target surface may be output digitally as serial ASCII.

In one embodiment the controller embodies a programmable logic controller. The controller may be operably linked to a power supply. In another embodiment the controller may include a switch adjustable to provide a level of product below which a signal is activated indicating a level of product has fallen below the preset level. The controller may include a digital and/or analog input.

The system may employ an alert device which is a light, audible alarm, transmitter operable to transmit a wired or wireless signal to a remote device, and/or a computer. The controller may be operable to output a signal to a computer or network server, in addition to or independent of activating the alert device.

In another embodiment the system may include a housing containing the sensor and controller. The sensor and/or controller may include wiring, cable or the like for connection to a power supply. The sensor and sensor and controller may be mounted to a top surface of the container. In the case of containers which include a compressor, such as a refrigerated container, the sensor and/or controller may be connected to the compressor to operate on power supplied thereby. The container may be any type of container such as but not limited to a refrigeration container, ice maker, ice storage container, or the like. In some embodiments the system may include an alert device including a status light mounted exterior from the container. The controller may be operable to output a signal via wi-fi, land line, 3G or 4G mobile, or smartphone application to a network, host system, computer, personal digital assistant (PDA), phone, Bluetooth, or smartphone in the form of a text, alert, data, email, voice mail, recorded message, or instant message to indicating an alert to restock the container.

In another embodiment a signal may be sent to the vendor source so that the product may be restocked without the need for the proprietor of the container to contact the vendor independently. It will be apparent to those skilled in the art that more than alert device in the form of an indicator such as lights, audible alarms, wired and/or wireless transmitters and the like may be employed in a single system.

In accordance with further embodiments, one or more sensors are included which may monitor temperature in the container, compressor temperature, status of power supply, inventory levels, compressor power draw, merchandiser power loss and other conditions, and may be operable to send signals indicating status, alerts or the like via wi-fi, land line, 3G or 4G mobile, smartphone applications or the like to a device such as a host system, computer, PDA, phone, Bluetooth, smartphone, etc. in the form of a text, alert, email, voice mail, recorded message, instant message or the like.

Systems employing the disclosed sensors provide a less expensive alternative and easier retrofit to existing containers than conventional load cells. For example, instead of adding load cells to an existing ice container, a system including one or more of a sensor, controller and indicator can be provided in a box which can be mounted to the top of a container such as an ice box. A single hole can be drilled in the top of the ice box to permit the signal to be transmitted to the ice in the ice box, and the sensor/controller connected to the power supplied by the compressor. Such an arrangement is hundreds of dollars less expensive, and provides longer running time without breakdowns due to zero load stress and moving parts, compared to conventional load cells. Systems in accordance with present disclosure save the supplier of product from unneeded deliveries and mechanic site visits, and save the store owner the problems associated with having inadequate inventory and frequent mechanical breakdown of conventional load cells.

### BRIEF DESCRIPTION OF THE DRAWINGS

For the purposes of illustration, there are forms shown in the drawings that are presently preferred, it being understood, however, that the invention is not limited to the precise arrangements and instrumentalities shown.

FIG. 1 is a schematic diagram of a system in accordance with an aspect of the present disclosure;

FIG. 2 is a schematic diagram of an ice box having a sensor, controller and indicator (status light) situated on the top thereof in accordance with an aspect of the present disclosure;

FIG. 3 is a block diagram of a system suitable for providing notification of a condition in a container; and

FIG. 4 is a block diagram of a system suitable for carrying out methods in accordance with one or more embodiments of the present invention.

### DETAILED DESCRIPTION OF THE PRESENT INVENTION

The following is a detailed description of the subject matter provided to aid those skilled in the art in practicing the present invention. Those of ordinary skill in the art may make modifications and variations in the embodiments described herein without departing from the spirit or scope of the present invention. Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. All publications, patent applications, patents, figures and other references mentioned herein are expressly incorporated by reference in their entirety.

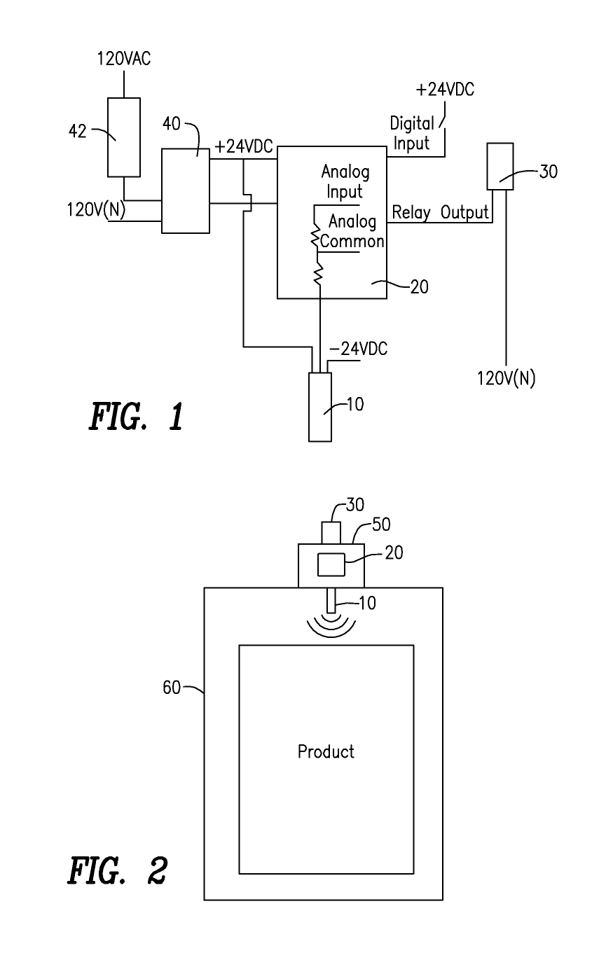

With reference to FIG. 1, an inventory monitoring system 2 includes a sensor 10, controller 20 and alert device 30. Sensor 10 may be an ultrasonic depth measurement device which operates by measuring the time required for an ultrasonic pulse to travel to and from a target surface. Distance may be output as an analog signal between for example 0 to 10 volts, 4-20 mA, pulse width modulation (PWM). In one embodiment a 0-10 signal (from sensor) is employed using 2 resistors (1 kohm) to form a voltage divider wherein the controller 20 only receives 0-5 volts due to equipment limitations. It will be apparent to the skilled artisan that other embodiments may use pulse width modulation (PWM), and custom-made sensors may be employed. Measurements may also be output digitally as serial ASCII. Suitable sensors are available commercially from Automationdirect.com, for example model SU2-A1-0E (Ultrasonic, 18 mm diameter, 18-30 VDC, 0-10 VDC output, 200-1,500 mm nominal sensing distance).

Sensor 10 is operably connected to controller 20 such as but not limited to a programmable logic controller. Suitable controllers are commercially available from Automationdirect.com of Cumming, Ga. under the trade name CLICK, such as CLICK Model C0-02DR-D Micro PLC. Controller 20 may be linked to an auxiliary power supply available for example from Automationdirect.com such as a 0.5 amp AC system power supply Model C0-00AC. Controller 20 may include a switch adjustable to provide the level of product below which a signal is activated indicating the product level is low and should be restocked. Controller 20 is operably connected to alert device 30. Controller 20 may include digital and/or analog input and is operable to provide an output signal to alert device 30. Alert device 30 may be a light, alarm, wired or wireless signal, etc. In one embodiment, once the product level goes beyond the preset limit, alert device 30 is activated, and may remain activated until the product is restocked above the preset level.

As discussed in further detail below, the controller may be operable to output a signal to a computer or network server, in addition to or independent of activating the alert device 30.

The sensor 10 and controller 20 may be connected to a power supply 40, which may be connected to a circuit breaker 42.

Now referring to FIG. 2, a housing 50 including sensor 10 and controller 20 may be mounted to the top of a container 60 such as an ice container and connected to any suitable power supply. A single hole can be drilled in the top of the container 60, for example, an ice box as shown, to permit the signal to be transmitted to the ice in the ice box, and the sensor 10 and/or controller 20 connected to power supplied by the compressor of the ice box. Alert device 30, such as a status light, may be mounted on the exterior of the container 50 and or on housing 50 so that the low level will be apparent to a person responsible for restocking the container. In one embodiment a controller may output a signal indicating status, alerts or the like via wi-fi, land line, 3G or 4G mobile, smartphone applications or the like to a device such as a host system, computer, PDA, phone, Bluetooth, smartphone, etc. in the form of a text, alert, data, email, voice mail, recorded message, instant message or the like, for example, to alert the responsible personnel to restock the container. In another embodiment a signal may be sent to the vendor source so that the product may be restocked without the need for the proprietor of the container to contact the vendor independently. It will be apparent to those skilled in the art that more than one indicator such as lights, audible alarms, wireless signals and the like may be employed in a single system.

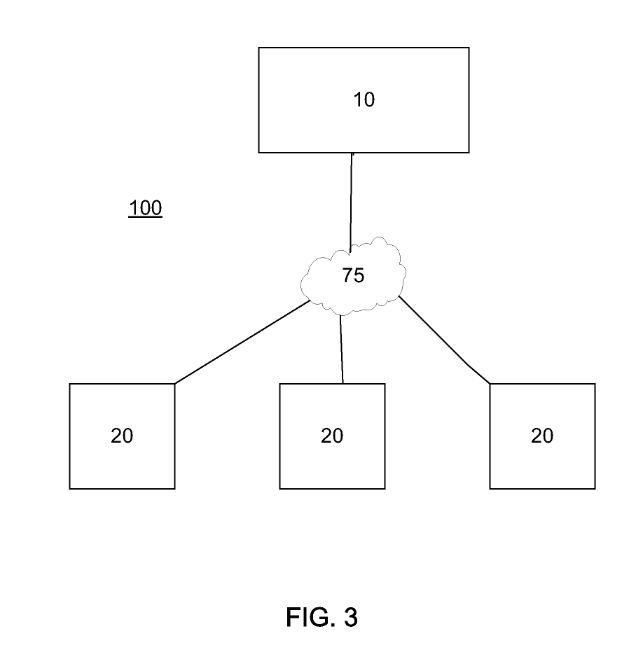

FIG. 3 is a block diagram illustrating an example of a system 100 for providing notification of a condition in a container.

The system 100 preferably includes at least one server 10 coupled to one or more controllers 20 over a network 75, such as the Internet. The server 10 and controllers 20 may be operable to carry out computing activity (e.g., the execution of suitable software code) in connection with implementing the functions and actions of the system 100 disclosed and described herein.

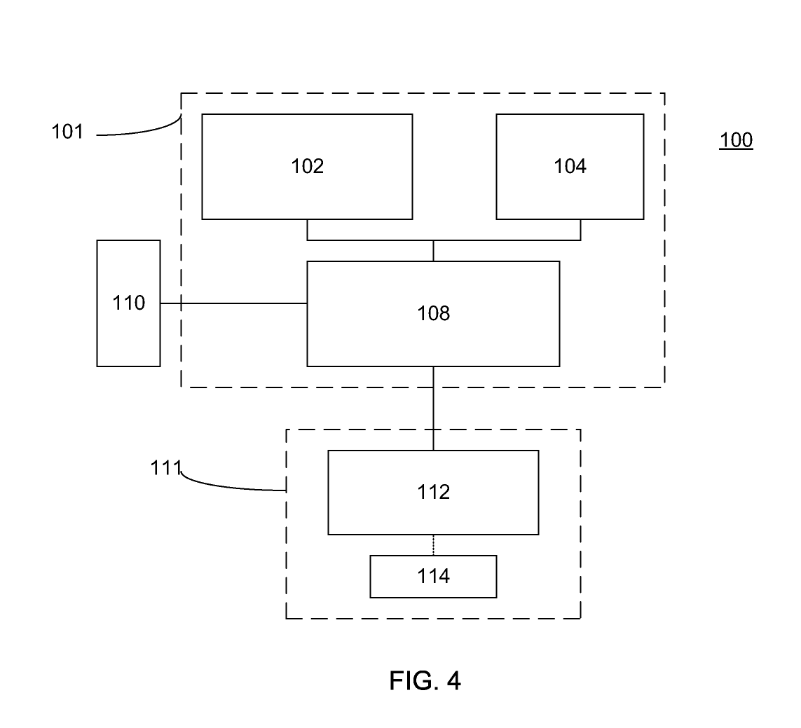

By way of example, the server 10 and/or the controller 20 may be implemented using known hardware, firmware, and/or software, as well as specialized software for carrying out specific functions and actions desirable for implementing embodiments of the invention. For example, with reference to FIG. 4, the server 10 and/or the controllers 20 may include a computer 101, which includes a data processing unit (or processor) 102 and a memory 104 operatively coupled by way of a data and/or instruction bus 106. The processor 102 may be implemented utilizing any of the known hardware, such as a digital microprocessor, a computer (such as a portable, a stationary and/or a distributed computing system), or any of the other known and/or hereinafter developed data processing units. The memory 104 may be implemented by way of separate hardware or may be disposed within the data processing unit 102, and any of the known hardware and/or software for implementing the memory function may be employed.

Data are preferably input to, and output from, the data processing unit 102 by way of an input/output device (or I/O interface) 108. Operators of the system 100 may desire to input software programs and/or data into the computer 101 by way of an external memory 110 that is coupled to the I/O interface 108 by way of a suitable link (such as a cable, wireless link, etc.) The external memory 110 may be implemented via a flash-drive, disc, remotely located memory device, etc.

The server 10 and/or the controllers 20 may also include an interface device 111, which is operatively coupled to the I/O interface 108 of the computer 101 via a suitable link, such as a cable, wireless link, etc. The interface device 111 includes at least one display 112, as well as an input device 114, such as a keyboard, mouse, voice recognition system, etc. The operators of the system 100, such as an IT professional (on the server 10 end) or a manager (on the controller 20 end), preferably utilizes the interface device 111 to provide information to the computer 101 in connection with entering appropriate data and/or programs into the system 100.

The computer 101 manipulates data via suitable software code in accordance with various embodiments of the invention and may display results on the display 112 for consideration by the various operators (IT professionals, users, etc.). In accordance with well-known techniques, the results may also be stored within the memory 104 of the computer 101, output and saved on the external memory device 110, and/or provided in any of a number of other ways.

It is noted that the functional blocks illustrated in FIGS. 3-4 may be partitioned as shown or may be partitioned in any other way, such as in an integral fashion. By way of example, the system 100 may be implemented utilizing a portable, stationary, or distributed computer operating under one or more suitable computer programs. Further, one or more of the functional blocks of the system 100 may be remotely located from the others, such as in a distributed (e.g., networked) system. It will be apparent that one or more controllers 20 may be connected to a computer on-site, which in turn is connected to a server 10. The signal may activate software in a server 10 or a networked computing device which provides details regarding the conditions in the container 60, such as the volume of product remaining in the container, estimated time to empty, etc.

Irrespective of how the system 100 is implemented and/or partitioned, it preferably carries out one or more methods for providing notification of conditions in a container. In accordance with further embodiments, one or more sensors may be included which may monitor temperature in the container, compressor temperature, status of power supply, inventory levels, compressor power draw, merchandiser power loss and other conditions, and are operable to send signals via one or more controllers indicating status, alerts or the like via wi-fi, land line, 3G or 4G mobile, smartphone applications or the like to a device such as a host system, computer, PDA, phone, Bluetooth, smartphone, etc. in the form of a text, alert, email, voice mail, recorded message, instant message or the like.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. An inventory monitoring system operable to read the level of inventory in a container and provide a signal indicating that the container is ready to be restocked, the system comprising a sensor mountable in a position on or within a container and operable to transmit a signal into an interior of a container to a target surface of an inventory in a container and receive a return signal, the sensor operably linked to a controller, and an alert device operably linked to the controller wherein the controller is operable to provide an output signal to the alert device when the level of inventory in a container falls below a preset level.

2. The system according to claim 1 wherein the sensor comprises an ultrasonic depth measurement device operable to measure the time required for an ultrasonic pulse delivered from the sensor to travel to and from a target surface.

3. The system according to claim 2 wherein a distance from the sensor to a target surface is output as an analog signal between 0 to 10 volts.

4. The system according to claim 3 wherein a 0-10 volt signal from the sensor is employed using 2 resistors to form a voltage divider wherein the controller only receives 0-5 volts.

5. The system according to claim 2 wherein the sensor employs pulse width modulation (PWM).

6. The system according to claim 2 wherein a distance from the sensor to a target surface is output digitally as serial ASCII.

7. The system according to claim 1 wherein the controller comprises a programmable logic controller.

8. The system according to claim 1 wherein the controller is operably linked to a power supply.

9. The system according to claim 1 wherein the controller comprises a switch adjustable to provide a level of product below which a signal is activated indicating a level of product has fallen below the preset level.

10. The system according to claim 1 wherein the controller comprises a digital and/or analog input.

11. The system according to claim 1 wherein the alert device is a light.

12. The system according to claim 1 wherein the alert device is an audible alarm.

13. The system according to claim 1 wherein the alert device is a transmitter operable to transmit a wired or wireless signal to a remote device.

14. The system according to claim 1 wherein the alert device comprises a computer.

15. The system according to claim 1 wherein the controller is operable to output a signal to a computer or network server, in addition to or independent of activating the alert device.

16. The system according to claim 1 further comprising a housing containing the sensor and controller.

17. The system according to claim 1 wherein at least one of the sensor and controller comprise a means for connection to a power supply.

18. The system according to claim 1 comprising a container, wherein the sensor and controller are mounted to a top surface of the container.

19. The system according to claim 18 further comprising a compressor wherein the sensor and/or controller are connected to the compressor to operate on power supplied by the compressor.

20. The system according to claim 18 wherein the container is an ice storage container.

21. The system according to claim 18 wherein the alert device comprises a status light mounted exterior from the container.

22. The system according to claim 18 wherein the a controller is operable to output a signal via wi-fi, land line, 3G or 4G mobile, or smartphone application to a network, host system, computer, personal digital assistant (PDA), phone, Bluetooth, or smartphone in the form of a text, alert, data, email, voice mail, recorded message, or instant message to indicating an alert to restock the container.
